(19) United States
(12) Patent Application Publication
(10) Pub. No.: US 2023/0156596 A1
(43) Pub. Date: May 18, 2023

(54) Wireless Communication Apparatus and Method

(71) Applicant: Essence Security International (E.S.I.) Ltd., Herzeliya Pituach (IL)

(72) Inventors: Ohad AMIR, Herzeliya Pituach (IL); Yossi YOSSEF, Herzeliya Pituach (IL)

(21) Appl. No.: 17/916,424

(22) PCT Filed: Mar. 31, 2021
(86) PCT No.: PCT/IL2021/050362

§ 371 Date: Sep. 30, 2022

(30) Foreign Application Priority Data
Apr. 1, 2020 (GB) 2004822.9

(51) Int. Cl. H04W 52/02; H04L 5/00

(52) U.S. Cl. CPC H04W 52/0216; H04W 52/0219; H04L 5/0048

(57) ABSTRACT

Wireless communication is effected by signaling, in a beacon, that a time period following the beacon is to be used for communication. In the event that the beacon indicates no communication in that time period, there is an opportunity for listening devices to enter a sleep mode before the next anticipated beacon. A pending address frame can follow the beacon to indicate which listening devices are addressed for communications within the time period, and scheduling of such communications. Non-participating listening devices also have an opportunity for entry into the sleep mode.

### RELATED APPLICATION/S

This application claims the benefit of priority of U.K. Application No. 2004822.9 filed on 1 Apr. 2020, the contents of which are incorporated herein by reference in their entirety.

### FIELD

The present disclosure is concerned with wireless communication apparatus, and a method of conducting wireless communication.

### BACKGROUND

Digital wireless communication between devices is generally effected through establishment of agreed communication protocols. A protocol is a set of rules which enables a communication from one device to be intercepted and correctly decoded by another device. Devices may communicate with each other using any number of protocols. For example protocols in accordance with or similar to FEE Standard 802.15.4 2015 for Low-Rate Wireless Networks may use a first device, referred to herein as a master device, to communicate with one or more devices selected, as needed, from a set of devices (herein slave devices).

Communication protocols are commonly defined in the context of genera well-established models for defining such protocols in a layered conceptual model. This allows for interoperability of devices, applications and media. One such model is the Open Systems interconnection (OSI) model. In the OSI1 model, a physical layer (PHY) defines the physical hardware and electronics which establishes the means of communication from one device to another. So, in the context of a wireless communication standard, a pre-agreed PUY level protocol will define radio frequencies for transmission of signals, and will also define the manner of division of the available communication resource to enable communication in a multi-device network. Divisions of a communication resource may be by time, frequency or space.

The PHY layer may define superframes that are consecutive blocks of time within each of which one or more PHY frames are transmitted. The superframes may be defined as having a beacon at the commencement of each superframe, to be transmitted by a master device for detection by other devices capable of receiving signals emitted by the master device. The beacon may be provided by more than one type of frame. For example IEEE 802.15.4-2015 defines Beacon frames and Enhanced Beacon frames. However, as used here the term a “beacon frame” is intended to encompass any type of frame that provides a beacon.

Certain communication protocols may define that the beacon frame include a pending bit and a pending address field. The pending bit can be set to indicate that there is to be an upcoming communication. The pending address field may be used to identify those slave devices with which the communication is to occur.

For power sensitive devices, such as those that are battery operated, it is desirable to implement measures that conserve stored energy. One way of doing this is for a device to place itself in a low power (“sleep”) state for periods when it is not in use. One feature of a protocol which defines specific timings during which no activity is expected of a slave device, is that the slave device can put itself into a sleep state until such time as it is expected to perform another function. So, in the context of a protocol wherein beacon frames are known to be transmitted at particular timings, a slave device need only be placed in a listening mode at such a time that a beacon frame may be expected. So, the slave device can be configured to put itself in a “listen” state, to listen for each beacon to determine, based on the pending bit and addresses in the pending address field, whether the slave device is required to remain active. If the slave device determines that the beacon frame indicates no communication in that superframe, or that the communication in that superframe is not directed at that slave device, then the slave device can return to the sleep state for the remaining duration of that superframe.

Communication protocols also define data structures at various further layers of the OSI model. So, for instance, at the media access control (MAC) layer, the superframe will be structured for MAC level interpretation and decoding. It may be convenient also to include “sleep” and “listen” modes at MAC layer level.

### BRIEF DESCRIPTION OF THE SEVERAL VIEWS OF THE DRAWING(S)

FIG. 1 is a schematic illustration of a wireless communication network in accordance with a described embodiment;

FIG. 2 is a schematic illustration of a wireless communication device configured as a master device of the network illustrated in FIG. 1;

FIG. 3 is a schematic illustration of a wireless communication device configured as a slave device of the network illustrated in FIG. 1;

FIG. 4 is a flow diagram illustrating a method of communicating from the perspective of a master device in accordance with a described embodiment;

FIG. 5 is a flow diagram illustrating a method of communicating from the perspective of a slave device in accordance with a described embodiment;

FIG. 6 is an illustration of a timeline indicating example superframes in accordance with disclosed embodiments;

FIG. 7 is an illustration of a beacon frame in accordance with disclosed embodiments; and

FIG. 8 is an illustration of a pending address frame in accordance with disclosed embodiments.

### DESCRIPTION OF EMBODIMENTS

In general terms, in embodiments described herein, wireless communication is effected by signalling, in a beacon, that a time period following the beacon is to be used for communication. In the event that the beacon indicates no communication in that time period, there is an opportunity for listening devices to enter a sleep mode before the next anticipated beacon. A pending address frame can follow the beacon to indicate which listening devices are addressed for communications within ihe time period, and scheduling of such communications. Non-participating listening devices also have an opportunity for entry into the sleep mode.

An aspect of the disclosure provides a wireless communication device configured to emit periodic beacons, each beacon comprising an indication as to whether a further communication, in addition to the beacon, is scheduled to occur in a time period following the beacon, wherein, in the event that the beacon indicates said further communication is to occur, the device is operable to emit a pending address frame in said time period, said pending address frame comprising addressing information for identification of one or more addressed slave devices that are to participate in said further communication and scheduling information for said further communication, and to participate in said further communication with respect to said scheduling information.

The further communication may be scheduled to occur before a next of said periodic beacons.

The pending address frame may be emitted before the further communication is scheduled to occur.

A time interval between respective ends of successive beacons may be fixed, wherein the pending address frame has a length that depends on a quantity of further communications in the time period that are indicated by the pending address frame.

The time period may be of a predetermined length, or inay be of a length signalled in the beacon.

The time period may be allocated into a plurality of predetermined timeslots. The time period may be allocated into a plurality of predetermined timeslots on the basis of timeslot allocation information signalled in the beacon.

The device may be operable to send, in the pending, address frame, communication direction information to indicate whether the further communication is to be to or from an addressed slave device.

The device may be operable to indicate, in the pending address frame, in the addressing information, that the further communication is intended for receipt by a plurality of slave devices, or for any slave device in receipt of the further communication.

The device may be operable to indicate, in the pending address frame, that a plurality of further communications are to occur in the time period, including addressing information tbr each further communication and scheduling information for each further communication.

The device may be operable, in the event that a single further communication is to occur in the time period, and said single further communication comprises a communication to be emitted by the device, to emit that communication instead of a pending address frame. The device may be operable to emit the single further communication in a defined timeslot immediately following the beacon. The further communication may include addressing information identifying one or more devices to which said further communication is intended.

Another aspect of the disclosure comprises a wireless communication device configured to respond to receipt of a beacon, to extract from the beacon an indication as to whether a further communication, in addition to the beacon, is scheduled to occur in a time period following the beacon, wherein, in the event that the beacon indicates said further communication is to occur, the device is responsive to receive a pending address frame in said time period subsequent to said beacon, said pending address frame comprising addressing information for identification of one or more addressed slave devices that are to participate in said further communication and scheduling information for said further communication, the device being responsive to addressing information, indicative that the device is to participate in a further communication, to be in a condition to participate in said further communication in accordance with said scheduling information.

The device may be operable in an active mode or a low-power mode, the device being operable to enter the active mode in order to be responsive to receipt of the beacon.

The device may be operable to enter the low-power mode in the event that the beacon contains an indication that no further communication is scheduled to occur in the time period following the beacon.

The device may be operable to enter the low-power mode in the event that, on receipt of a pending address frame, the pending address frame does not indicate any further communication scheduled for participation by the device in the time period subsequent to said beacon.

The device may be operable to enter the low-power mode in the event that a received pending address frame indicates that the device is intended to participate in a further communication within the time period, and to enter the active mode before said scheduled further communication is to occur.

The device may be operable to enter the active mode ready to detect receipt of a beacon a time period after receipt of a preceding beacon, the time period either being predetermined or being of a length signalled in the beacon.

The device may be responsive to receipt of a beacon to receive the pending address frame before the further communication.

The device may be operable to allocate the time period into a plurality of predetermined timeslots. The timeslots may be predetermined on the basis of thneslot allocation information signalled in the beacon.

The device may be operable to extract, from a received pending address frame, communication direction information to indicate whether a further communication is to be to or from an addressed slave device.

The device may be operable to detect, as an alternative to a pending address frame, a single further communication following a beacon and, on completion of that further communication, to enter a low-power mode.

The device may be operable to receive the single further communication in a defined timeslot immediately following the beacon.

The device may be operable to extract, from the further communication, addressing information identifying one or more devices to which said further communication is intended.

Another aspect of the disclosure provides a method of wireless communication comprising emitting periodic beacons, each beacon comprising an indication as to whether a further communication, in addition to the beacon, is scheduled to occur in a time period following the beacon, wherein, in the event that the beacon indicates said further communication is to occur, emitting a pending address frame in said time period, said pending address frame. comprising addressing information for identification of one or more addressed slave devices that are to participate in said further communication and scheduling information for said further communication, and effecting said further communication with respect to said scheduling information.

Another aspect of the disclosure provides a wireless communication method at a wireless communications device, in response to receipt at said device of a beacon, comprising extracting from the beacon an indication as to whether a further communication, in addition to the beacon, is scheduled to occur in a time period following the beacon, wherein, in the event that the beacon indicates said further communication is to occur, receiving a pending address frame in said time period subsequent to said beacon, said pending address frame comprising addressing information for identification of one or more addressed slave devices that to participate in said further communication and scheduling information for said further communication, and in the event that the addressing information indicates that the device is to participate in a further communication, placing the device in a condition to participate in said further communication in accordance with said scheduling information.

Embodiments disclosed herein may comprise a storage medium storing computer executable instructions which, when executed by a device, cause that device to perform an aspect of the disclosure.

Embodiments disclosed herein may comprise a signal bearing computer executable instructions which, when executed by a device, cause that device to perform an aspect of the disclosure.

The disclosure can also be embodied as a signal emitted by a device as disclosed herein. Embodiments disclosed herein seek to provide a protocol which in some conditions may reduce power consumption in wireless communication devices implementing said protocol.

Embodiments are particularly directed at a synchronous communication protocol in which a slave device is configured to operate in a wake state with reference to a beacon transmitted by a master device.

Coordination of the wake state with the beacon may be achieved in a number of ways. In a first instance, a slave device may be configured to enter the wake state at a predetermined time, at which a beacon may be expected. The timing of this entry into the wake state may be established by hardware or software of the slave device. To prevent timing drift affecting the operation of this approach, the timing may be reset by reference to the time of receipt of one or more preceding beacons.

In another approach, a dedicated beacon listening part of the slave device may be in listening state, and be configured to listen for beacon frames. Receipt of a beacon frame may trigger the beacon listening function of the slave device to cause remaining processing portions of the slave device to wake. The beacon listening part of the slave device may be permanently in the listening state, or may enter a sleep mode on a synchronised basis, in this way, the slave device can conserve power consumptionby most le device when a beacon has not been received.

In embodiments disclosed herein, changes to power management, which may have a power saving effect, are achieved by limiting (i.e. potentially keeping to a minimum) the length of the beacon frame. The beacon length is limited by defining, firstly, a beacon frame comprising a pending bit which, if set, causes slave devices to be in a listening mode for a second, pending address frame, that is transmitted by the master after it transmits the beacon. The pending address frame, if sent, comprises a pending address field. So, the slave devices only listen to the Pending Address Frame if the beacon contained the pending bit (or, more generally, a pending field).

A beacon frame may comprise error checking information. So, in such a case, a slave device will be configured to listen for the duration of the whole beacon frame, to enable error checking of the beacon frame to ensue, to verify that the information that they have read is correct. However, if, once the beacon frame has been read, it can be concluded that the pending bit has not been set, then all slave devices can return to sleep after the beacon frame, and do not need to listen further for the pending address frame.

In an embodiment, each frame (the beacon frame and the pending address frame, and the frames used for the selected communications) has a header which may be counted as an overhead. For example, at the PHY level of the frame, the header may comprise a preamble part, a sync part and a length pail, and where the PHY layer delivers a MAC frame, the MAC frame will have a MAC header and a MAC payload, etc. Since each frame has its own header, splitting a payload amongst multiple frames consumes more time (and hence more power) to read or, similarly, to transmit.

However, in some applications, such as in monitoring systems, for example security systems or other threat detection and/or verification systems, communications between the master and a slave may be relatively rare, i.e. in most PHY superframes there is no such communication. For such applications, even though there is more overhead when a separate Pending Address Frame is transmitted (as opposed to incorporating the Pending Address Field into the Beacon Frame), for the majority of superframes there will be no Pending Address frame transmitted and hence, shortening a beacon frame by excluding pending address information therefrom will mean less wasted listening time and thus more opportunity for power saving over time.

Further, to reduce the number of calculations needed to be performed by each slave device for them to determine when the next beacon frame will be, a time interval between respective ends of successive beacons is fixed. For example, a fixed size beacon frame may be employed (i.e. the size of each beacon frame may be the same). As a result of the time interval between respective ends of successive beacons being fixed, then for superframes of a fixed duration, the slave only needs to determine when the Beacon Frame has ended to be able to determine when the next superframc and hence the next Beacon Frame may commence.

Further, if the Pending Address field were incorporated into the Beacon, a fixed Pending Address field would be needed. This means the Pending Address field would need to be long enough for the case in which the maximum number of slave devices are to be addressed. For example, if there were up to time slots in the superframe available for communications with respective slave devices, then the Pending Address Field would need to be long enough to identify all of the selected slave device addresses and the respective time slots allocated for communications with each selected slave device.

However, by contrast, for embodiments of the present disclosure, as pending addresses are signalled external to the beacon frame, the frame that defines the pending addresses (such as the Pending Address frame) need only be long enough to define those addresses of the slave devices for those time slots which are to be used. For example referring to the case above, if only two slave devices are to be involved in communications, then the remaining 6 fields are not needed, and further power may be saved.

In other embodiments, rather than time slots, the times allocated or the respective communications may be defined by time, e.g. a delay time after the beacon frame as opposed to a time slot index.

The Pending Address Frame may also define the address of the master.

The communication(s) may be defined in Pending Address Frame as being to the master or from the master. In other embodiments it may be predetermined by the protocol or in the beacon, such that all in communications defined in the Pending Address Frame have the same direction with respect to the master. For example, they may all be from the master to the slave(s). As another example, a protocol may be devised that every communication between a master and a particular slave device is in the opposite direction to the preceding communication between the master and that particular slave device. As another example, a preceding communication between a master and that particular slave device may comprise an indication as to the direction of a subsequent communication, so that, for example, a first communication may direct the recipient device to send an acknowledgement or other reply in response, when scheduled to do so. Alternatively, the protocol may define that a device that receives a communication or a communication of a certain type is required to transmit an acknowledgment signal at a predefined time within a superframe or a predefined time in relation to a time at which the said communication is received.

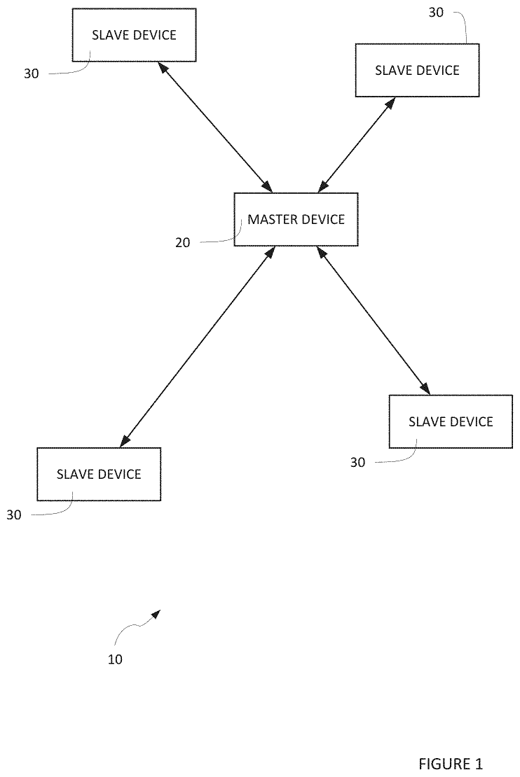

As shown in FIG. 1, a network 10 according to a disclosed embodiment comprises a master device 20 in range of wireless communication with a plurality of slave devices 30.

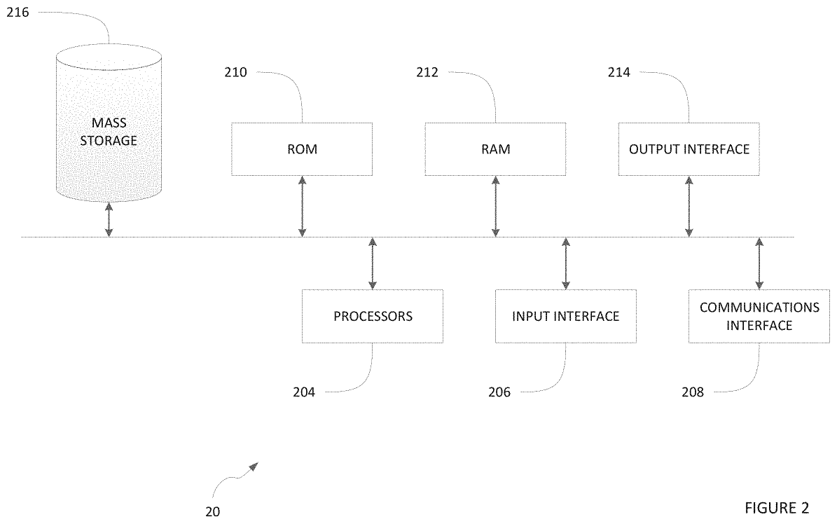

As shown in FIG. 2, the master device 20 is a computer apparatus, in structure and function. It may share, with general purpose computer apparatus, certain features, but some features may be implementation specific, given the specialised function for which the master 20 is to be put. The reader will understand which features can be of general purpose type., and which may be required to be configured specifically for use as a master communication unit in a wireless communication network. In some embodiments, however, the master device 20 may more specifically be a control hub of a threat detection and/or verification system, for example an alarm system. In such embodiments the master device 20 may also act as a hub for home automation,

The master 20 thus comprises one or more processors 204, either generally provisioned, or configured for other purposes such as mathematical operations, audio processing, managing a communications channel, and so on.

An input interface 206 provides a facility for receipt of user input actions. Such user input actions could, for instance, be caused by user interaction with a specific input unit including one. or more control buttons and/or switches, a keyboard, a mouse or other pointing device, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 214 is operable to provide a facility for output of signals to a user or another device. Such output could include a display signal for driving a local video display unit (VDU) or any other device.

A communications interface 208 implements a communications channel with one or more recipients of signals. In the context of the present embodiment, the communications interface is configured to cause emission of signals structured in accordance with a communications protocol as will be described in due course. The signals are configured to occur in a timing framework defined by a sequence of superframes defined in time, with master-slave synchronisation with respect to the superframe timing, the superframes commencing at regular intervals. The intervals between commencement of superframes part of the agreed protocol, and slave devices are configured to detect beacons at the commencement of the respective superframes as per the predetermined timing. The structure and timing of superframes may be capable of alteration, so as to present shorter or longer superframes as required in given circumstances. Changes of communication protocol of this type may be signalled from the master to slave devices.

The processors 204 are operable to execute computer programs, in operation of the encoder. In doing this, recourse is made to data storage facilities provided by a mass storage device 208 which is implemented to provide large-scale data storage albeit on a relatively slow access basis, and will store, in practice, computer programs and, in the current context, video presentation data, in preparation for execution of an encoding process,

A Read Only Memory (ROM) 210 is preconfigured with executable programs designed to provide the core of the functionality of the master device 20, and a Random Access Memory 212 is provided for rapid access and storage of data and program instructions in the pursuit of execution of a computer program.

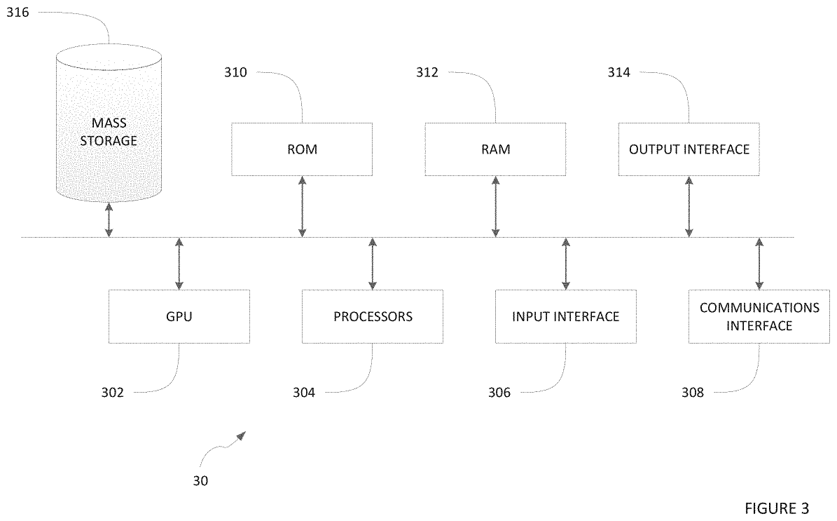

FIG. 3 illustrates a typical slave device 30, for engagement in communication with the master device 20. The slave device 30 is a computer apparatus, in structure and function. It may share, with general purpose computer apparatus, certain features, but some features may be implementation specific. The reader will understand which features can be of general purpose type, and which may be required to be configured specifically for use as a slave communication unit in a wireless communication network. In some embodiments however, the slave is a peripheral device of a threat detection and/or verification system, for example a passive infrared (PIR) detector, a camera, an entry point (e.g. door/window) sensor, etc.

The slave device 30 thus comprises one or more processors 304, either generally provisioned, or configured for other purposes such as mathematical operations, audio processing, managing a communications channel, and so on.

An input interface 306 provides a facility for receipt of user input actions. Such user input actions could, for instance, be caused by user interaction with a specific input unit including one or more control buttons and/or switches, a keyboard, a mouse or other pointing device, a speech recognition unit enabled to receive and process speech into control commands, a signal processor configured to receive and control processes from another device such as a. tablet or smartphone, or a remote-control receiver. This list will be appreciated to be non-exhaustive and other forms of input, whether user initiated or automated, could be envisaged by the reader.

Likewise, an output interface 314 s operable to provide a facility for output of signals to a user or another device. Such output could include a display signal for driving a local video display unit (VDU) or any other device.

A communications interface 308 implements a communications channel with one or more recipients of signals. In the context of the present embodiment, the communications interface is configured to enable reception of a signal structured in accordance with the aforementioned communications protocol which will be described in due course, and to participate in communications as scheduled with the device.

The processors 304 are operable to execute computer programs, in operation of the encoder. In doing this, recourse is made to data storage facilities provided by a mass storage device 308 which is implemented to provide large-scale data storage albeit on a relatively slow access basis, and will store, in practice, computer programs and data in preparation for execution of the communication process.

A Read Only Memory (ROM) 310 is preconfigured with executable programs designed to provide the core of the functionality of the slave device 30, and a Random Access Memory 312 is provided for rapid access and storage of data and program instructions in the pursuit of execution of a computer program.

Although not shown, it will be understood that in some embodiments the slave 30 is battery powered, i.e. it does not have access to a mains power supply. Likewise, the master 20 may be battery powered.

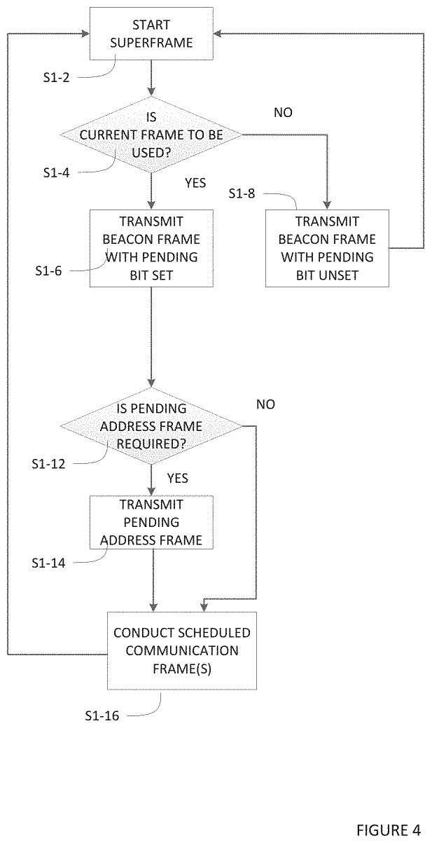

As shown in FIG. 4, the process of communicating during a superframe, in accordance with an embodiment, commences, in step S1-2 at a specific time regularity with respect to previous frames. In step S1-4, a determination is made by the master 20 as to whether the current superframe is to be employed for contention free communication between the master and one or more slaves, for example during a contention free period within the superframe. If contention free communication is to be employed, then the beacon frame is emitted from the master 20 with the Pending Bit set in step S1-6. Otherwise, the beacon frame is emitted from the master 20 with the Pending Bit unset in step S1-8. If step S1-1 is executed, the routine proceeds to the next superframe.

In some embodiments, regardless of whether a communication is to be employed during a contention free period, a contention access period may be provided within the superframe, for example before the contention free period.

If Step S1-6 is e then in step S1-12, a determination is made as to whether a Pending Address Frame is required. In some embodiments, if a transmission is to be made from or to the master 20, a Pending Address Frame will always be emitted by the master 20 to follow the. Beacon Frame. If this is the case, then the determination step S1-12 is trivial and unnecessary. In other embodiments, the determination may be made by the master 20 as to whether the Pending Address Frame is necessary, or whether data to be communicated on the channel can be signalled to or from the correct recipient slave unit in another way. For instance, a data frame may include addressing information, or the data frame may be for all slave devices (or there may only be one slave device on the network).

If the Pending Address frame is required, then this frame is emitted by the master 20 in step S1-14. Then, in step S1-16, communications are conducted between the master 20 and addressed slaves 30 at respective scheduled times as defined in the Pending Address frame, prier to completion of the superframe and commencement of the next superframe.

The disclosure does not exclude the possibility that a Pending Address frame may schedule communications in subsequent superframes, such as if a large communication needs to be broken into fragments to enable it to be accommodated, although scheduling of such fragments may alternatively be controlled by respective Pending Address frames in respective superframes.

The communicated frame (referred to in the accompanying drawings as frame for a selected address) may optionally be a command or data frame that is in accordance with IEEE 802.15.4-2015 or serve an equivalent purpose thereto.

in one embodiment, the Pending Address Frame is, or is in, a PPDU (Physical Protocol Data Unit) distinct from the Beacon Frame. A PPDU has a header, and a MAC frame or more generally a PSDU (PECP Service Data Unit, where PLCP is the Physical Layer Convergence Protocol). Each PPDU referred to herein may be any PHY Protocol Data Unit in accordance with the OSI model, as would be understood by a person skilled in the art.

For example, in some embodiments, each PPDU may have a structure in accordance with IEEE standard 802.15.4-2015. However, it should be appreciated that adherence to that Standard, or any other Standard, is not a prerequisite for performance of any embodiment disclosed here in or any other embodiment that could be devised by the reader with the teaching of the present disclosure.

The PPDU containing the Pending Address Frame MAC frame may follow a short time after the PPDU containing the Beacon Frame MAC. In some embodiments, the slave devices may sleep between the PPDU containing the Beacon Frame and the PPDU containing the Pending Address Frame, but in other embodiments they may stay awake dining the intervening time.

However, in another embodiment, a single PPDU could potentially aggregate a Beacon MAC frame and be followed by a Pending Address MAC frame. For such an embodiment there may be error checking on at least the beacon MAC frame to validate its contents.

In any case, it may be desirable to include error checking on each PPDU frame.

Each of the further communications may comprise one or more PPDUs.

Certain embodiments provide a functionality to account for a case in which only one communication is to be conducted, and the communication is from master to slave. The same approach could be employed for a multicast communication, from a master device to a plurality of slave devices, or more generally a broadcast communication from a master device to any slave device capable of receiving the communication.

In that case it may be unnecessary to transmit a Pending Address Frame. By this, further power savings can be potentially achieved. In this case, the pending bit in the beacon frame is still employed to indicate whether a communication is intended in that superframe but, instead of thereafter transmitting a pending address frame to identity the slave device needed for the communication, the master device simply transmits, subsequent to the beacon frame, the communication to the or each slave device, with (if required) the address of the intended recipient slave device included in the communication. Thus, in some embodiments, if the pending bit is set but a Pending Address frame is not emitted (i.e. the “no” branch from step S-12), the master 20 emits an addressed frame, in step S1-16, prior to completion of the superframe and commencement of the next superframe.

In this case, all slave devices in the network would listen to that communication because the pending bit in the beacon frame would indicate that they should. However, upon reading the subsequently transmitted frame, each slave device would identify that the frame is not a Pending Address frame but is instead a control or data frame, and would discover, based on the address, whether the frame is a communication intended for that slave device or for a different slave device. Thus, at the conclusion of that frame, all of the slaves (or at least those that weren't the addressed slave) will return to sleep.

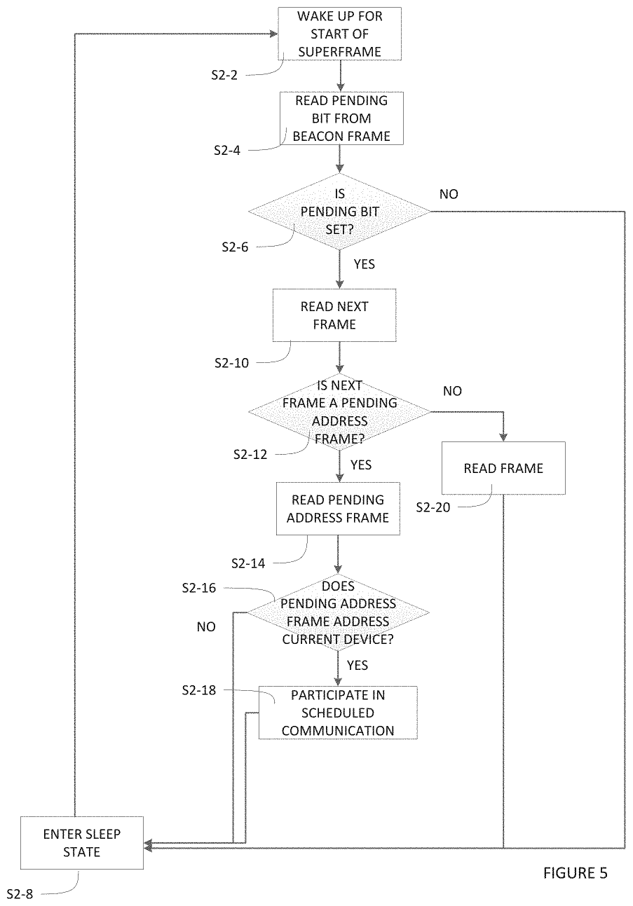

The manner in which a slave device “listens” to the channel with the intent of receiving information from the master device, will now be described with reference to FIG. 5.

As shown in FIG. 5, the slave device 30 enters an “awake” state, in step S2-2 in time for the commencement of a superframe. The timing of this wake-up is determined both by internal reckoning, on the basis of an accurate internal clock of the slave device 30, but also takes account of timing of receipt of beacon frames of preceding superframes, which gives an indication as to possible timing drift. The slave device 30 may be configured to enter the “awake” state a predetermined lead time before the predicted commencement of a superframe, to avoid the slave device still being in a “sleep” state when a beacon frame is received. The amount of lead time should be optimised to ensure that the device is not awake unnecessarily early, which would compromise power consumption saving achieved through use of the sleep state.

In step S2-4 the beacon has been received and the pending bit is read to determine, in step S2-6, if it is set or not. If it is set, then the superframe is being used for contention free transmission, and a frame following the beacon should be expected. Otherwise, if it is not set, then in step S2-8 the slave device returns to the sleep state.

In step S2-10, the next frame is read. In the general case, this next frame may be a. pending address frame or, in a special case, it may be a directly addressed frame (e.g. a data frame or a control frame, which in some embodiments is in accordance with IEEE 802.15.4-2015, but optionally may be any other type of frame).

If this next frame is a pending address frame, the pending address frame will signal whether further frames of the superframe are to be used for signalling data, and, if so, whether any of those frames are for signalling to the current slave device.

So, in step S2-12, the nature of the next frame is determined. If it is a pending address frame, then it is read by the slave device in step S2-14 and a determination is made in step S2-16 as to whether the information on the pending address frame indicates that the current slave device should be in a state to participate in further communications in the current superframe as scheduled on the pending address frame. If not, then the slave device returns to the “sleep” state (step S2-8) for the duration of the current superframe.

As per the above description of the master, the slave may be configured to receive a pending address frame containing scheduling information which indicates that the slave 30 should schedule itself to participate in communications in subsequent superframes. As above, this could be of particular usefulness if a multi-frame communication is necessary, such as for a bulk download/upload of data, and to avoid the network becoming blocked by a large communication with one slave device to the exclusion of all others.

If, on the other hand, it is determined in step S2-16 that the pending address frame indicates that the current slave device is scheduled to participate in further communications in the superframe then, in step S2-18, the current slave device is configured to effect the scheduled communication at the designated time. In some embodiments, if instead of a pending address frame, there is received a different type of frame (e.g. a data frame, control frame or other addressed frame) the frame is still read by the current slave device.

Following the participation in the scheduled communication in step S2-18, the slave device returns to the “sleep” state (step S2-8) for the remaining duration of the current superframe.

Further to the above, if in step S2-12 it is determined that the frame is not a pending address frame, then in step S2-20 it is read to determine the nature of the flame and whether it is intended for the device. Depending on the outcome of this determination, the content of the frame is read and, if intended for the device, appropriate action is taken. in the above examples, the “address” is in some embodiments a unique address, thus the communication may be a unicast communication. Optionally, in other embodiments the address may define a subset of devices within a set (e,g. it may an identifier shared by a plurality of devices), e.g. for multicasting. In some embodiments the address may comprise a group identifier (ID) (e.g. a device type, in some embodiments) and a unique ID. Multicasting may be for example to all devices having a group ID, or a mask may be applied to the unique ID field to provide a group ID.

The slave devices may return to sleep for any times in which they are not required to participate in communications, e.g. before and after a time slot that is allocated for them.

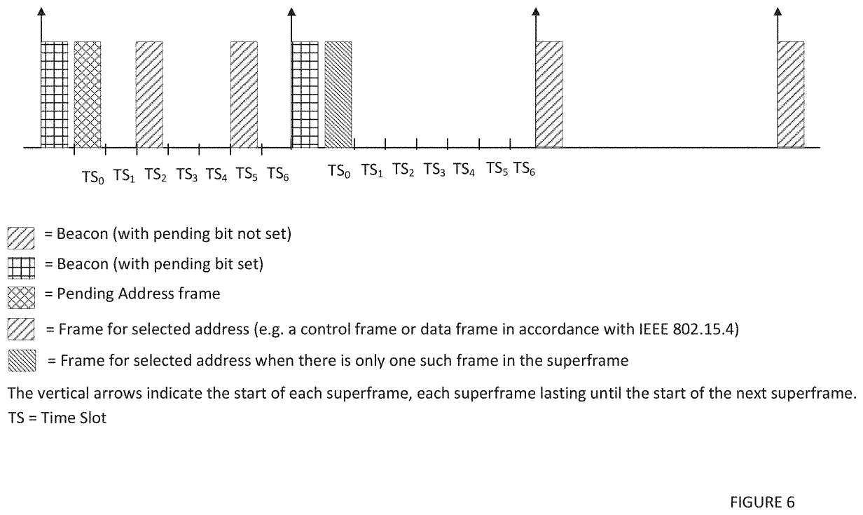

FIG. 6 illustrates, by example, a manifestation of this method. A communication channel is shown, with transmission scheduled over consecutive superframes of equal length. As illustrated, a first time period of each superframe is allocated to transmission of a beacon emitted by a master device. Thus, any slave device engaged with the communication channel should expect these beacons to be emitted at regular intervals.

Following this, each superframe is divided into 7 timeslots (TS) indexed from 0 to 6. As can be seen, the first superframe commences with a beacon with the pending bit set. As a result, all slave devices which receive this beacon, with the pending bit set, will respond by remaining in an awake state for subsequent transmissions. In this example, in the first superframe, a pending address frame follows in TS0. The pending address frame signals that communications will follow in timeslots TS2 and TS5 and will address devices which are intended to participate in those transmissions. This information, in the pending address frame, will indicate to those addressed devices that they will need to be awake at the indicated timeslots to participate in those communications. In some embodiments, the devices enter “sleep” state for time slots TS1 and TS3 and TS4 while waiting for these communications.

It will be appreciated that not every superframe need employ the above arrangement. There may be other types of frames which could be signalled in different ways, and devices may respond to other information carried in bits of the beacon or in information carried in one or more frames subsequent to the beacon.

Also, not all of an allocated time slot need necessarily be utilised. For example, a communication allocated to a timeslot may or may occupy all of the timeslot. For example, a given time slot may have a fixed duration, but the communication may last a variable duration that less than or greater than the fixed duration. For example, the variable duration may depend on the contents of the communication.

As illustrated in FIG. 6, the second superframe commences with a beacon with the pending bit set. In this case, however, there is only one frame subsequently signalled in the superframe. As shown, timeslot TS0 is occupied with a control frame or data frame for a selected address. In this case, it is not necessary to signal the frame in advance, because it is the only frame in the superframe after the beacon. There is thus no saving to be gained by transmitting a pending address frame on TS0 and then the signalled frame to the addressed device on a subsequent timeslot. All devices on the network can then sleep after that solitary signalled frame on TSP.

Third and fourth superframes are then illustrated, in which beacons have their pending bit unset. All devices then enter the sleep state immediately after the beacon, as no timeslots are then used in those superframes thereafter.

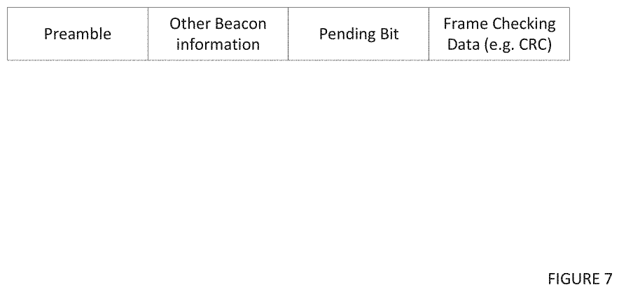

FIG. 7 shows a structure for an example beacon in accordance with disclosed embodiments. Simply put, the beacon comprises a preamble, detectable by recipient devices so as to define a beacon. The preamble may contain information designed to synchronise recipient devices, and may signal particular information relating to the mode of communication. Other beacon information, not relevant to the present disclosure may then follow. As illustrated, the pending bit (or, more generally, a pending data field) follows this other beacon information, but the order of these items is not material to performance. Finally, frame checking data, such as CRC bits, close the frame.

As will be appreciated, the form of the beacon may fit within the scope of a beacon as employed in the aforementioned IEE Standard, but with the pending address field omitted from the beacon.

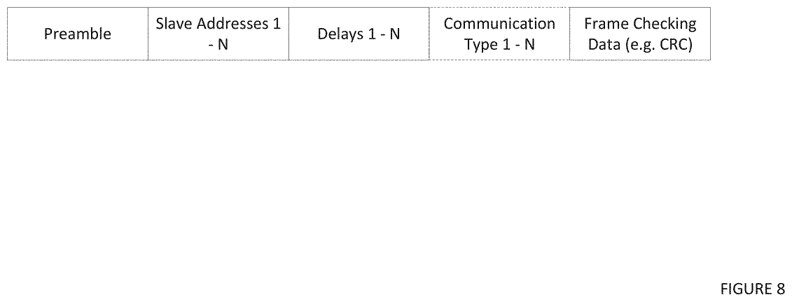

FIG. 8 then illustrates a typical pending address frame as employed in accordance with described embodiments. As for the beacon, a preamble is used to identify the frame. This might include an address of the master device emitting the frame. Following that, there is a sequence of slave address fields and delay fields. As shown, the address fields are placed first, followed by the delay fields. In an alternative approach, the address fields may be interlaced with the delay fields.

Each address field addresses a particular one of the slave devices or a group of slave devices, if group addressing is implemented) and a corresponding delay field signals when, in the superframe, that slave device should be active on the channel.

Communication type fields follow (or are interlaced), indicating for example whether the communication in the signalled frame is to be from the master to the slave or from the slave to the master. Deployment of this feature may be optional: in certain contexts it may be clear as to which direction communication must take place, or directionality may be fixed.

Finally, as before, frame checking, information, such as error checking and, optionally, correction, may be included as a tail to the frame.

While in the described embodiment, it is contemplated that the frame be implemented as or equivalent to a PPDU, it is also considered possible, within the scope of the present disclosure, to implement it as a MAC frame, in which case the preamble is a MAC preamble.

In addition, any priority document(s) of this application is/are hereby incorporated herein by reference in its/their entirety.

1. A wireless communication device configured to emit periodic beacons, each beacon comprising an indication as to whether a further communication, in addition to the beacon, is scheduled to occur in a time period following the beacon, wherein, in the event that the beacon indicates said further communication is to occur, the device is operable to emit a pending address frame in said time period, said pending address frame comprising addressing information for identification of one or more addressed slave devices that are to participate in said further communication and scheduling information for said further communication, and to participate in said further communication with respect to said scheduling information, wherein the device is operable, in the event that a single further communication is to occur in the time period, and said single further communication comprises a communication to be emitted by the device, to emit that communication instead of a pending address frame.

2. (canceled)

3. (canceled)

4. (canceled)

5. A device in accordance with claim 1 wherein the time period is allocated into a plurality of predetermined timeslots and, optionally, wherein the time period is allocated into a plurality of predetermined timeslots on the basis of timeslot allocation information signalled in the beacon.

6. (canceled)

7. A device in accordance with claim 1 operable to indicate, in the pending address frame, in the addressing information, that the further communication is intended for receipt by a plurality of slave devices, or for any slave device in receipt of the further communication.

8. A device in accordance with claim 1 operable to indicate, in the pending address frame, that a plurality of further communications are to occur in the time period, including addressing information for each further communication and scheduling information for each further communication.

9. (canceled)

10. A device in accordance with claim 1 operable to emit the single further communication in a defined timeslot immediately following the beacon.

11. A device in accordance with claim 9 operable to include, in the further communication, addressing information identifying one or more devices to which said further communication is intended.

12. A wireless communication device configured to respond to receipt of a beacon, to extract from the beacon an indication as to whether a further communication, in addition to the beacon, is scheduled to occur in a time period following the beacon, wherein, in the event that the beacon indicates said further communication is to occur, the device is responsive to receive a pending address frame in said time period subsequent to said beacon, said pending address frame comprising addressing information for identification of one or more addressed slave devices that are to participate in said further communication and scheduling information for said further communication, the device being responsive to addressing information, indicative that the device is to participate in a further communication, to be in a condition to participate in said further communication in accordance with said scheduling information, the device being operable to detect, as an alternative to a pending address frame, a single further communication following a beacon and, on completion of that further communication, to enter a low-power mode.

13-23. (canceled)

24. A method of wireless communication comprising emitting periodic beacons, each beacon comprising an indication as to whether a further communication, in addition to the beacon, is scheduled to occur in a time period following the beacon, wherein, in the event that the beacon indicates said further communication is to occur, emitting a pending address frame in said time period, said pending address frame comprising addressing information for identification of one or more addressed slave devices that are to participate in said further communication and scheduling information for said further communication, and effecting said further communication with respect to said scheduling information, wherein, in the event that a single further communication is to occur in the time period, and said single further communication comprises a communication to be emitted by the device, emitting that communication instead of a pending address frame.

25. A wireless communication method at a wireless communications device, in response to receipt at said device of a beacon, comprising extracting from the beacon an indication as to whether a further communication, in addition to the beacon, is scheduled to occur in a time period following the beacon, wherein, in the event that the beacon indicates said further communication is to occur, receiving a pending address frame in said time period subsequent to said beacon, said pending address frame comprising addressing information for identification of one or more addressed slave devices that are to participate in said further communication and scheduling information for said further communication, and in the event that the addressing information indicates that the device is to participate in a further communication, placing the device in a condition to participate in said further communication in accordance with said scheduling information, wherein the method comprises detecting, as an alternative to a pending address frame, a single further communication following a beacon and, on completion of that further communication, entering a low-power mode.

26. A non-transitory computer readable storage medium storing computer executable instructions which, when executed by a device, cause that device to perform a method comprising emitting periodic beacons, each beacon comprising an indication as to whether a further communication, in addition to the beacon, is scheduled to occur in a time period following the beacon, wherein, in the event that the beacon indicates said further communication is to occur, emitting a pending address frame in said time period, said pending address frame comprising addressing information for identification of one or more addressed slave devices that are to participate in said further communication and scheduling information for said further communication, and effecting said further communication with respect to said scheduling information, wherein, in the event that a single further communication is to occur in the time period, and said single further communication comprises a communication to be emitted by the device, emitting that communication instead of a pending address frame.

27. (canceled)

28. (canceled)

29. (canceled)

30. A method in accordance with claim 24 comprising allocating the time period into a plurality of predetermined timeslots and, optionally, allocating the time period into a plurality of predetermined timeslots on the basis of timeslot allocation information signalled in the beacon.

31. A method in accordance with claim 24 comprising indicating, in the pending address frame, in the addressing information, that the further communication is intended for receipt by a plurality of slave devices, or for any slave device in receipt of the further communication.

32. A method in accordance with claim 24 comprising indicating, in the pending address frame, that a plurality of further communications are to occur in the time period, including addressing information for each further communication and scheduling information for each further communication.

33. A method in accordance with claim 24 comprising emitting the single further communication in a defined timeslot immediately following the beacon,

34. A method in accordance with claim 24 comprising including, in the further communication, addressing information identifying one or more devices to which said further communication is intended.

35. A non-transitory computer readable storage medium in accordance with claim 26 wherein the method comprises allocating the time period into a plurality of predetermined timeslots and, optionally, allocating the time period into a plurality of predetermined timeslots on the basis of timeslot allocation information signalled in the beacon.

36. A non-transitory computer readable storage medium in accordance with claim 26 comprising indicating, in the pending address frame, in the addressing information, that the further communication is intended for receipt by a plurality of slave devices, or for any slave device in receipt of the further communication

37. A non-transitory computer readable storage medium in accordance with claim 26 wherein the method comprises indicating, in the pending address frame, that a plurality of further communications are to occur in the time period, including addressing information for each further communication and scheduling information for each further communication.

38. A non-transitory computer readable storage medium in accordance with claim 26 wherein the method comprises emitting the single further communication in a defined timeslot immediately following the beacon.

39. A non-transitory computer readable storage medium in accordance with claim 26 wherein the method comprises including, in the further communication, addressing information identifying one or more devices to which said further communication is intended.
